(19) United States
(12) Patent Application Publication
(10) Pub. No.: US 2014/0046680 A1
(43) Pub. Date: Feb. 13, 2014

(54) Online Health Assessment Providing Lifestyle Recommendations

(71) Applicant: Usana Health Sciences, Inc., Salt Lake City, UT (US)

(72) Inventors: David A. Wentz, Park City, UT (US); Brian Dixon, Salt Lake City, UT (US)

(73) Assignee: Usana Health Sciences, Inc., Salt Lake City, UT (US)

(21) Appl. No.: 13/964,868

(22) Filed: Aug. 12, 2013

Related U.S. Application Data
(60) Provisional application No. 61/682,097, filed on Aug. 10, 2012.

(51) Int. Cl. G06F 19/00

(52) U.S. Cl. CPC G06F 19/3431
USPC 705/2

(57) ABSTRACT

The present invention provides an online health assessment that collects information from an individual and uses the information to recommend changes to the individual's lifestyle, nutrition, and/or products that will assist the individual to maintain or improve a current level of health.

### CROSS-REFERENCE TO RELATED APPLICATIONS

This U.S. Patent Applications claims priority to U.S. Provisional Patent Application No. 61/682,097, filed Aug. 10, 2012, titled Online Health Assessment Providing Lifestyle Recommendations.

### BACKGROUND

With the fast pace of life today, many people find it difficult to maintain or improve their health. Even if a person has the desire to improve his health, he may not be aware of what changes are required to make the desired improvement. For example, a person may desire to simply feel better but may not know what factors may be preventing him from feeling as he desires.

Even when a person knows what general changes need to be made in his lifestyle to make a desired improvement, he may not know how to bring about the necessary changes. There are often many different factors that affect a person's desire or ability to make changes to his lifestyle. A person may be overwhelmed by these factors and may be unable to identify which factors may be the most beneficial to address.

### BRIEF SUMMARY

The present invention extends to methods, systems, and computer program products for providing an online health assessment. The online health assessment collects information from an individual and uses the information to recommend changes to the individual's lifestyle and/or nutrition and/or products that will assist the individual to balance, maintain, or improve a current level of health.

In one embodiment, a method for recommending changes to an individual's lifestyle and/or nutrition includes displaying a user interface to the user, the user interface requesting information regarding the health of the user. User input is then received to the user interface. The user input is analyzed to identify one or more lifestyle and/or nutrition/product recommendations to present to the user based on the user input. A lifestyle plan comprising one or more lifestyle and/or nutrition/product recommendations is then displayed to the user.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an exemplary networked environment in which the present invention can be implemented;

FIGS. 2A-2II illustrate various exemplary views of an online health assessment user interface;

FIGS. 3A-3C illustrate a portion of an exemplary lifestyle plan; and

FIG. 4 illustrates a flowchart of an exemplary method for selecting one or more lifestyle recommendations based on user input to an online health assessment.

### DETAILED DESCRIPTION

The present invention extends to methods, systems, and computer program products for providing an online health assessment. The online health assessment collects information from an individual and uses the information to recommend changes to the individual's lifestyle and/or nutrition and/or products that will assist the individual to balance, maintain, or improve a current level of health.

In one embodiment, a method for recommending changes to an individual's lifestyle and/or nutrition includes displaying a user interface to the user, the user interface requesting information regarding the health of the user. User input is then received to the user interface. The user input is analyzed to identify one or more lifestyle and/or nutrition/product recommendations to present to the user based on the user input. A lifestyle plan comprising one or more lifestyle and/or nutrition/product recommendations is then displayed to the user.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

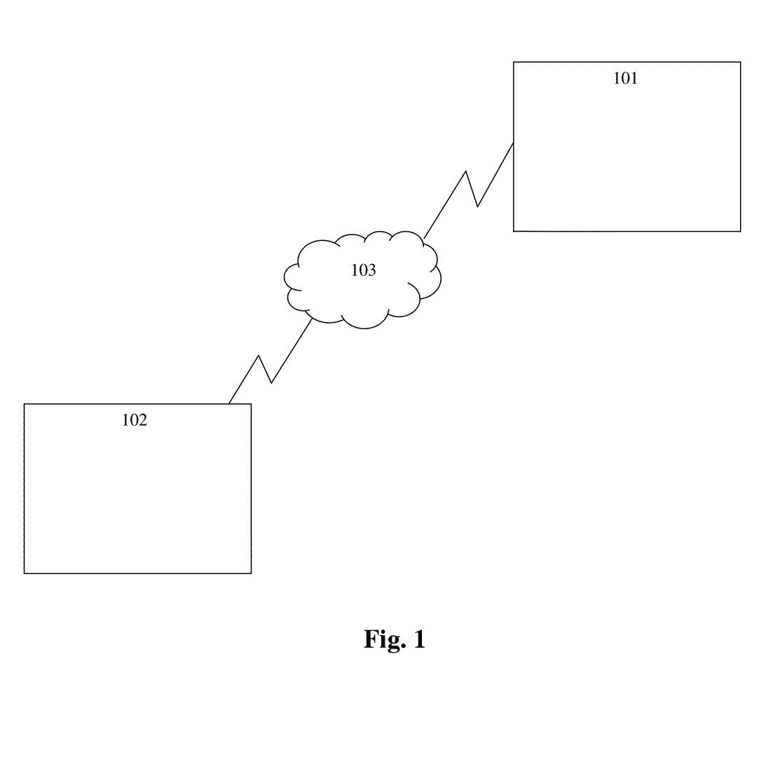

FIG. 1 illustrates an exemplary networked environment 100 in which the present invention can be implemented. Networked environment 100 includes computer system 101, computer system 102, and network 103. Network 103 can represent the internet and any of the various means of connecting to the internet. Accordingly, computer system 102 generally connects to computer system 101 via the internet although any other network could also be used.

Computer system 101 represents a computer system used by a provider of an online health assessment. Computer system 101 can therefore be one or more computer systems functioning as servers (including a cluster of servers (e.g. a cloud)), or any other computer system capable of communicating with computer system 102 to provide an online health assessment.

Computer system 102 represents the computer system used by a user to take the online health assessment provided by computer system 101. Accordingly, computer system 102 could be a tablet, laptop, or desktop computer, a mobile phone, or any other computer system capable of communicating with computer system 101 as further described below.

Although FIG. 1 depicts two computer systems communicating over a network to implement the online health assessment, the online health assessment could also be provided on a single system. For example, a mobile application can be installed on a mobile device which can provide an online health assessment as described below. In such cases, the mobile device (or other computer system) may or may not communicate with computer system 102 during the online health assessment (e.g. the mobile application may contain all the necessary logic to determine lifestyle and/or nutrition/product recommendations based on user input during the online health assessment). Accordingly, the present invention is not limited to any particular computer architecture.

According to embodiments of the invention, an online health assessment can be provided that identifies lifestyle and/or nutrition/product recommendations based on a user's input during the assessment. These lifestyle and/or nutrition/product recommendations can identify changes the user can make to his lifestyle and/or nutrition and/or products used to maintain or improve his health.

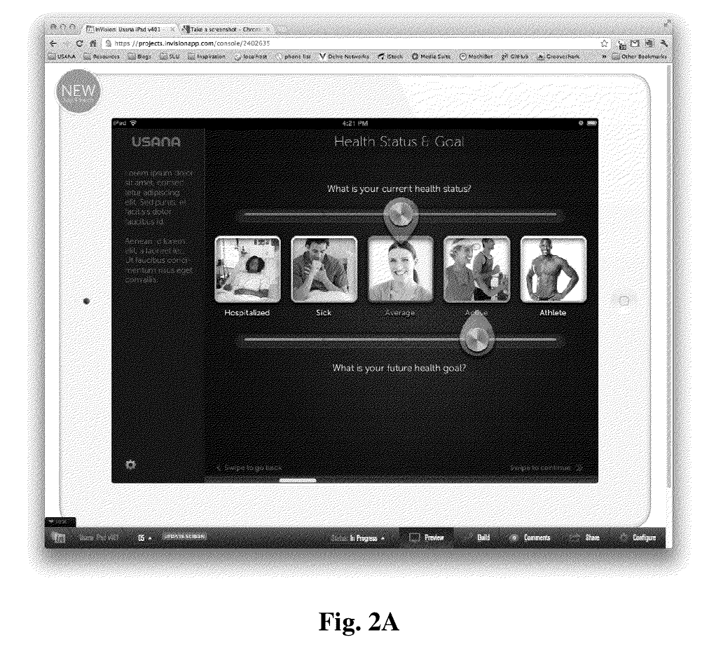

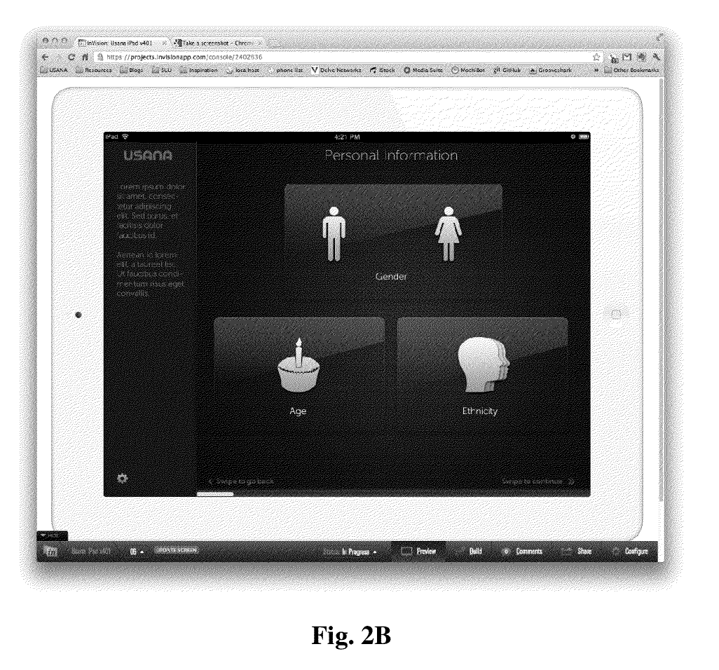

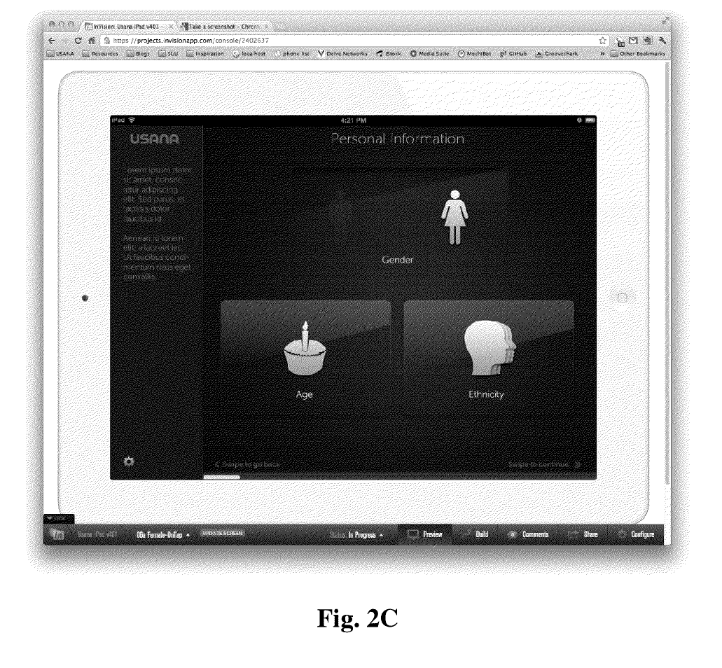

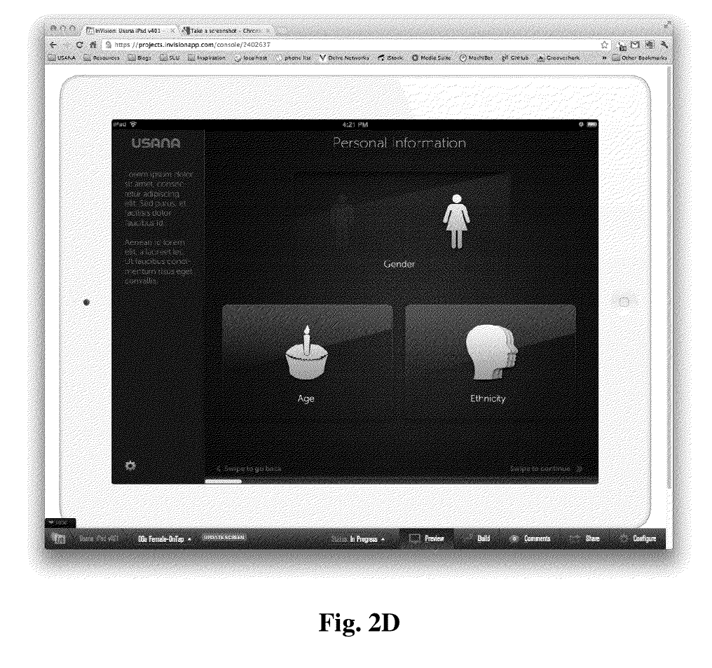

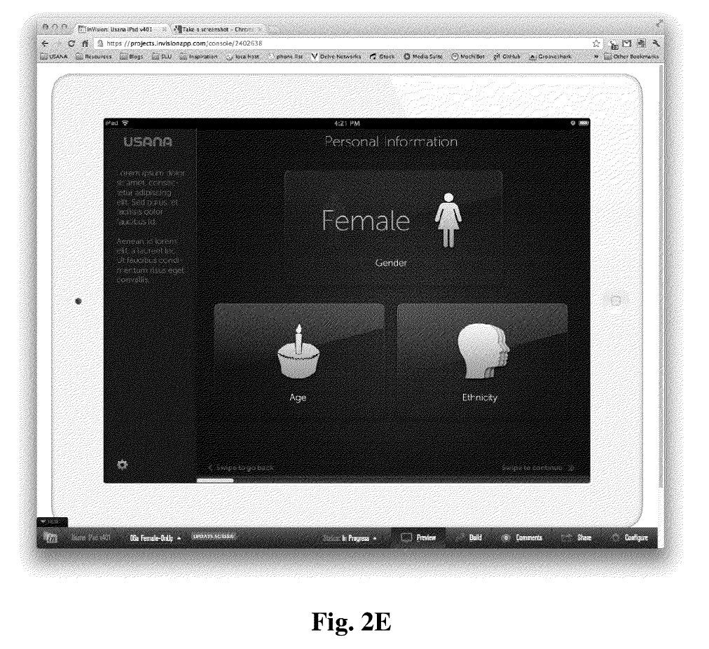

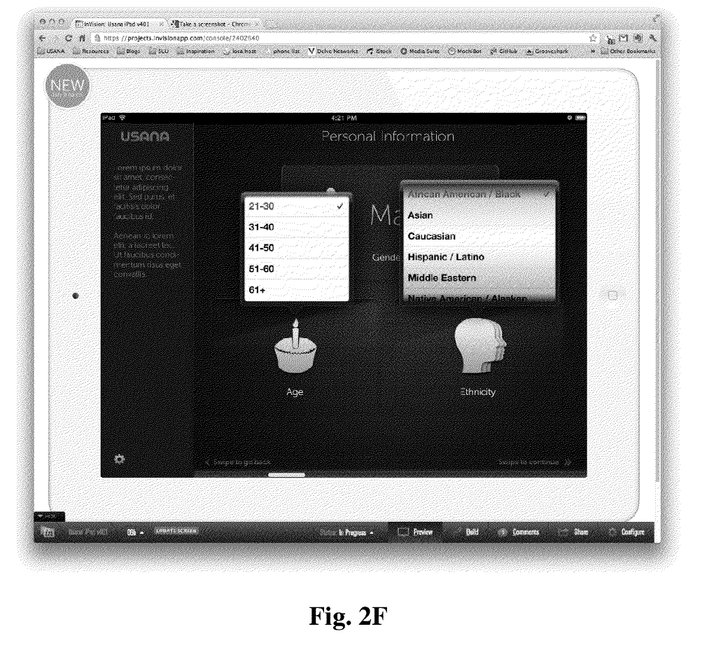

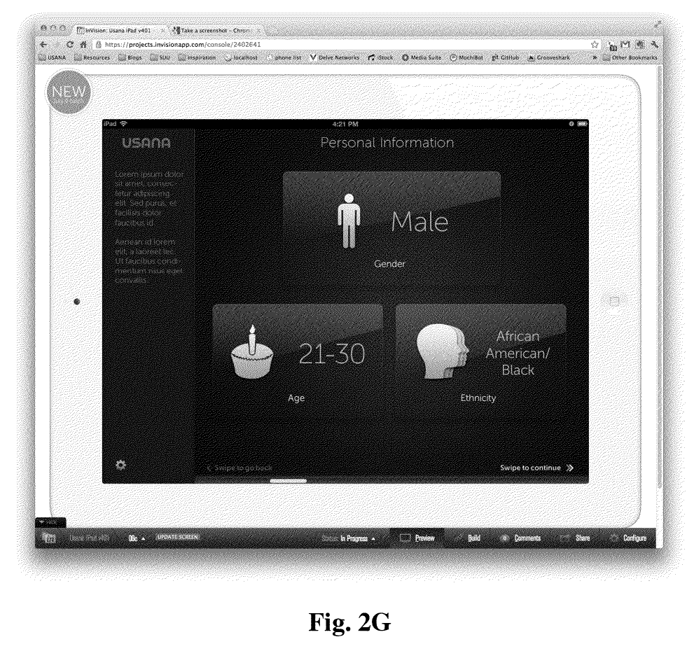

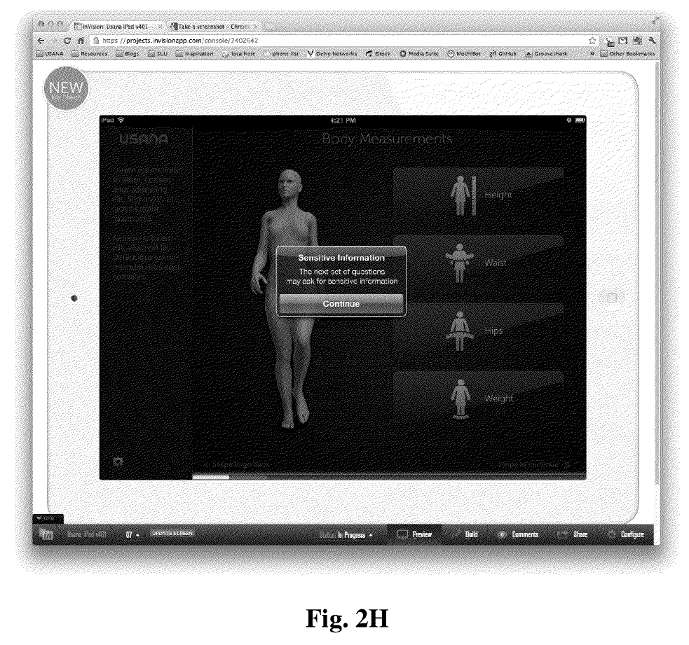

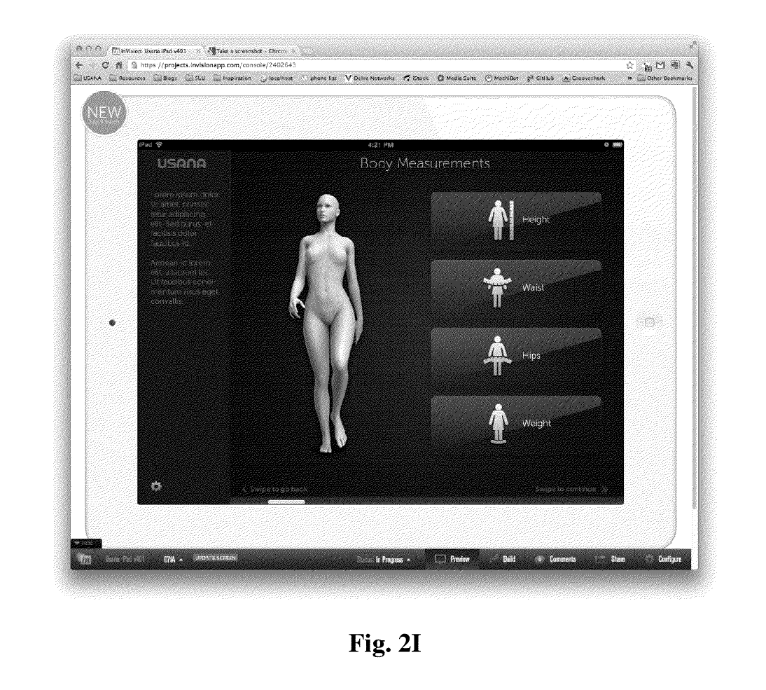

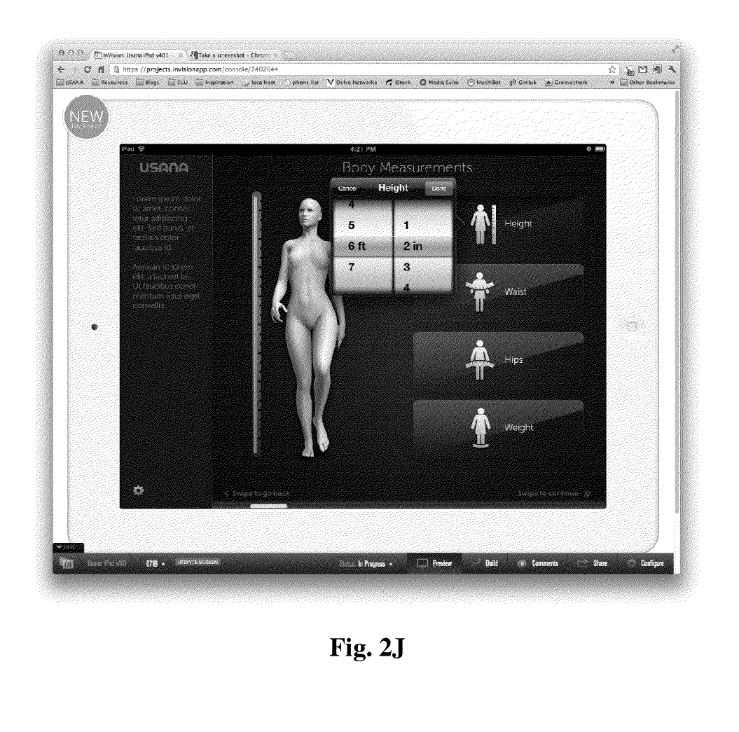

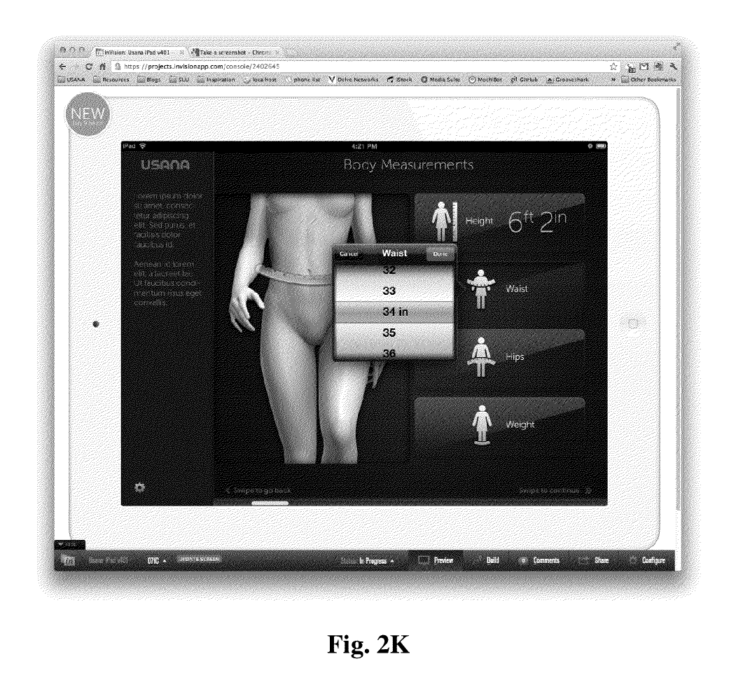

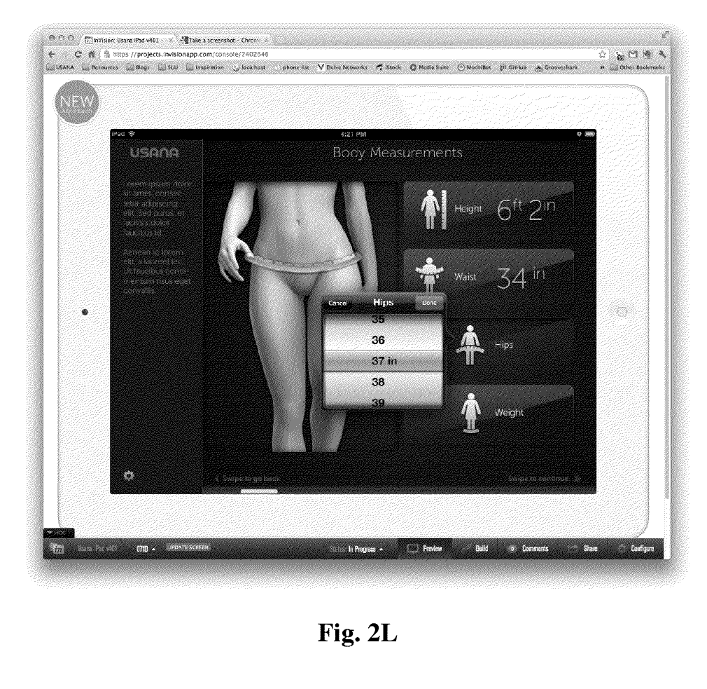

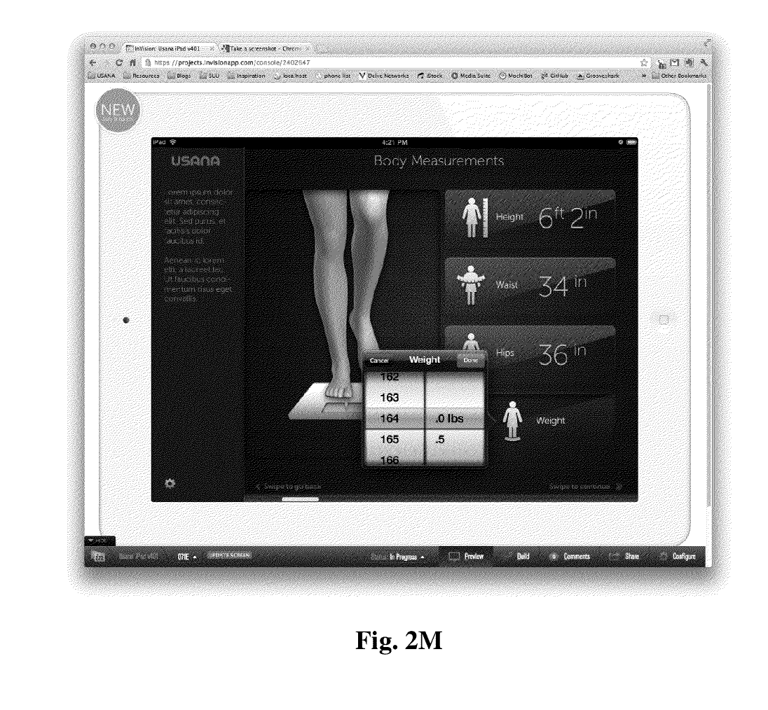

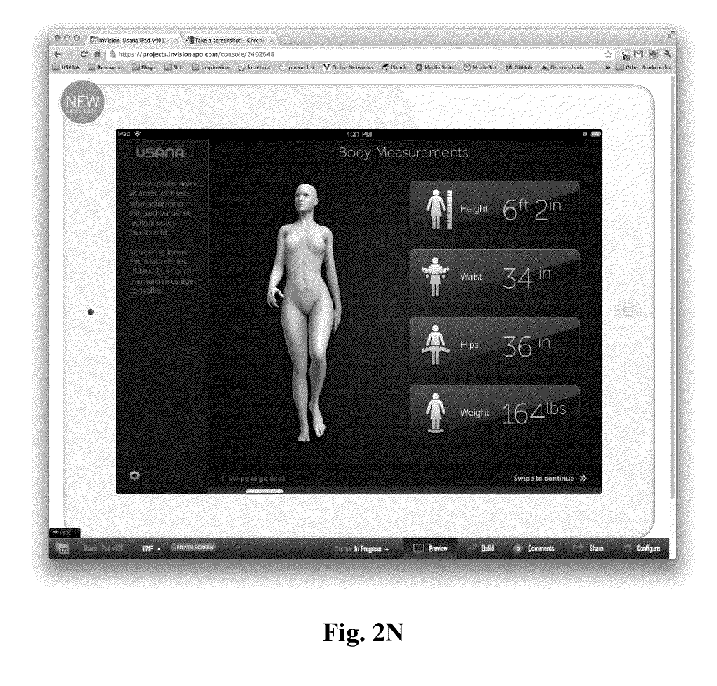

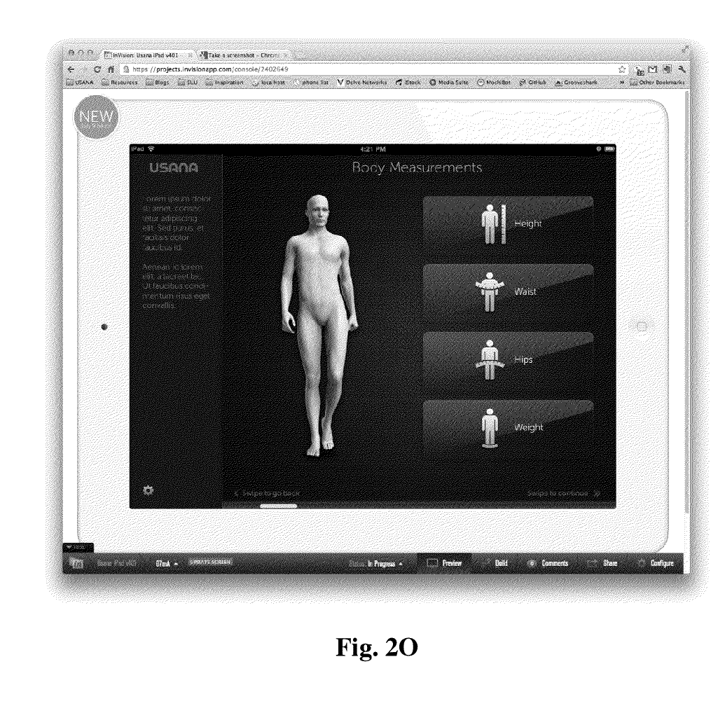

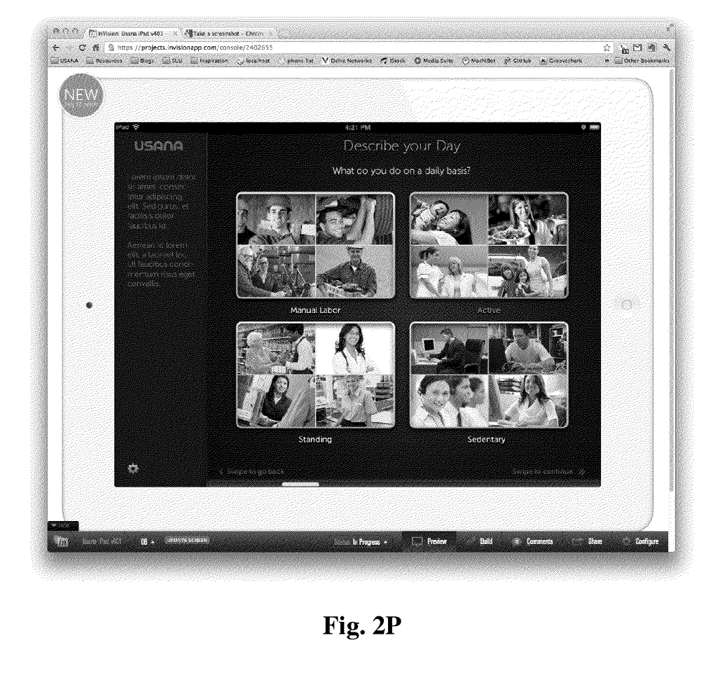

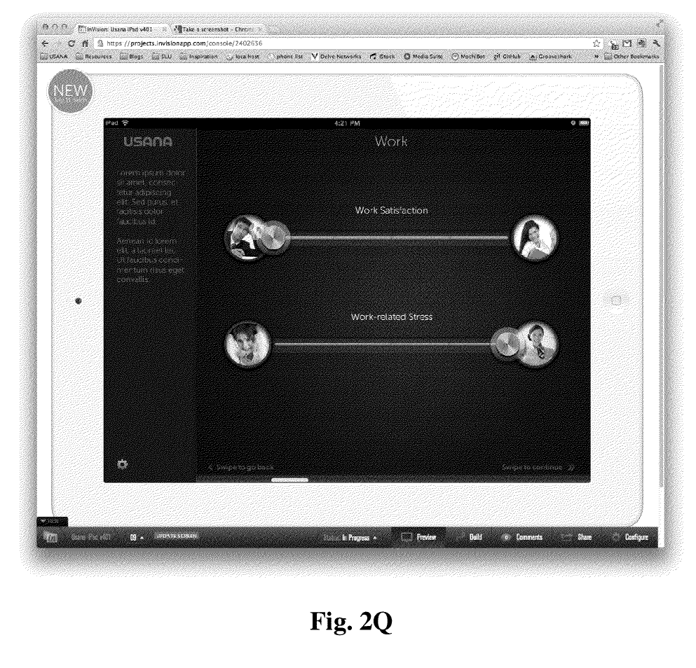

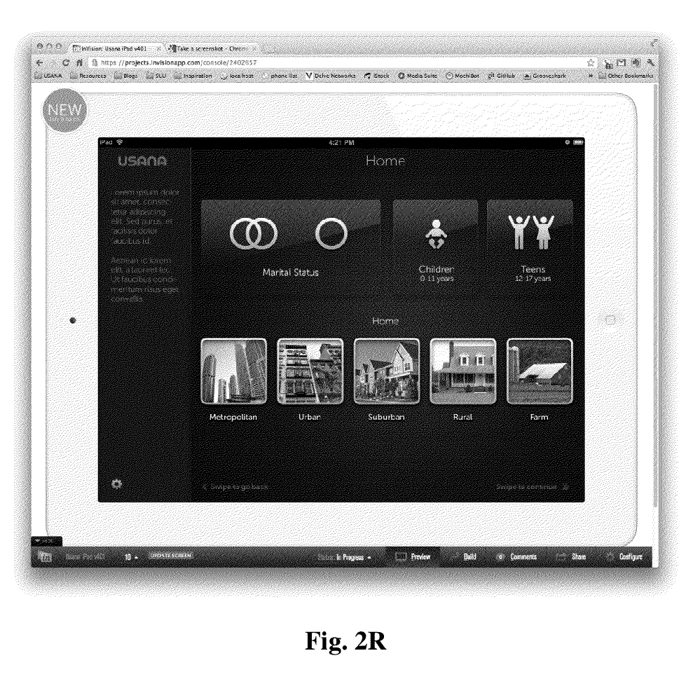

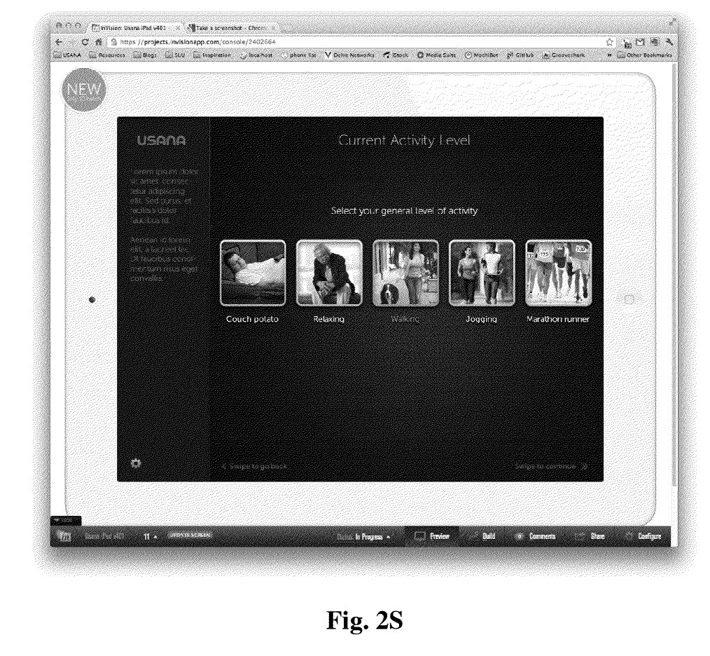

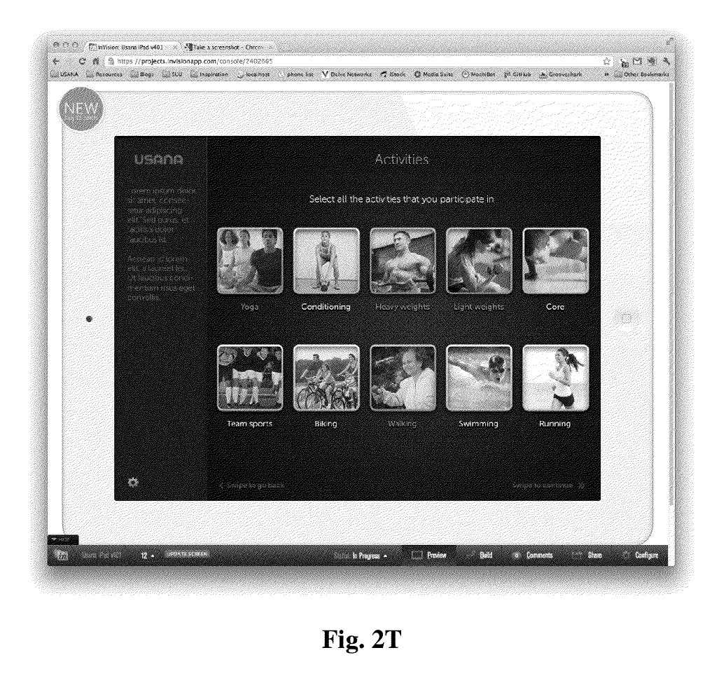

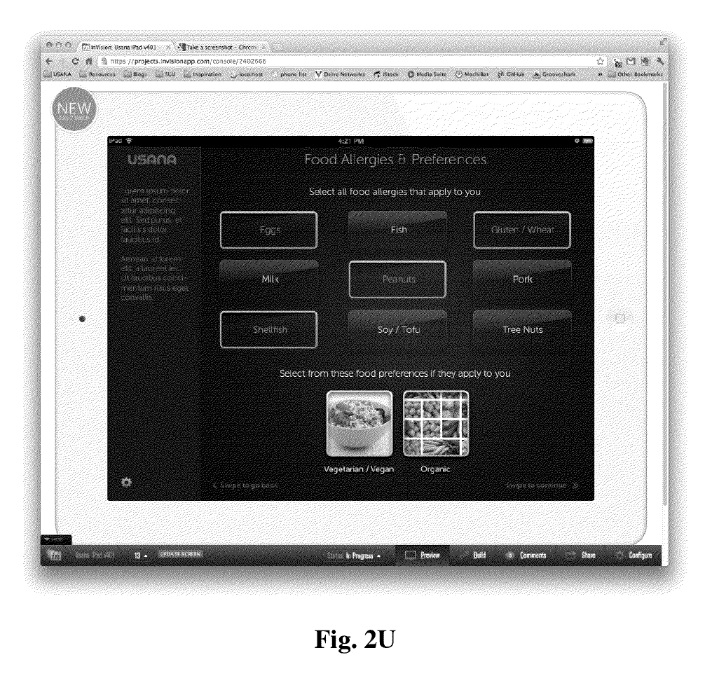

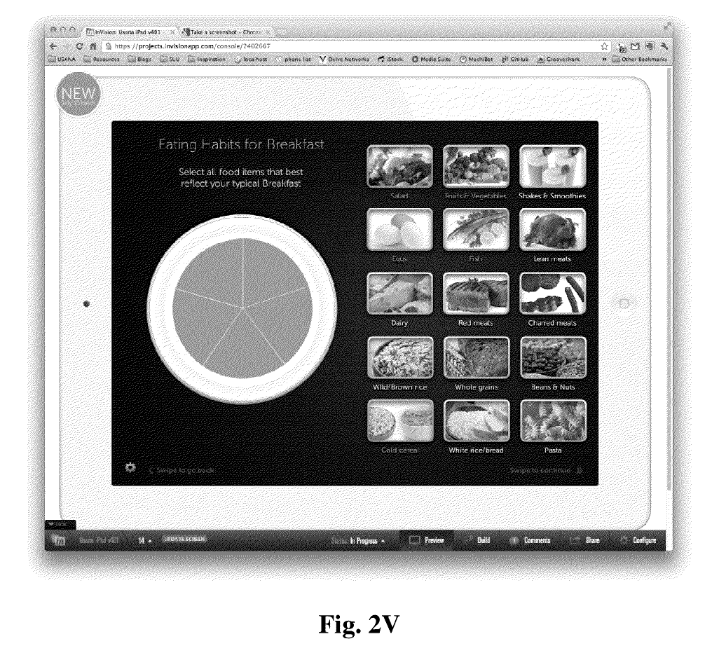

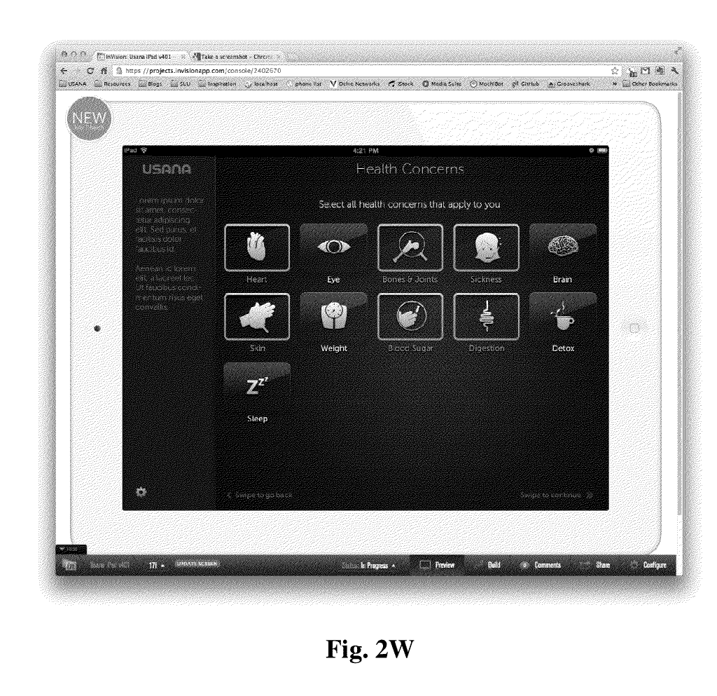

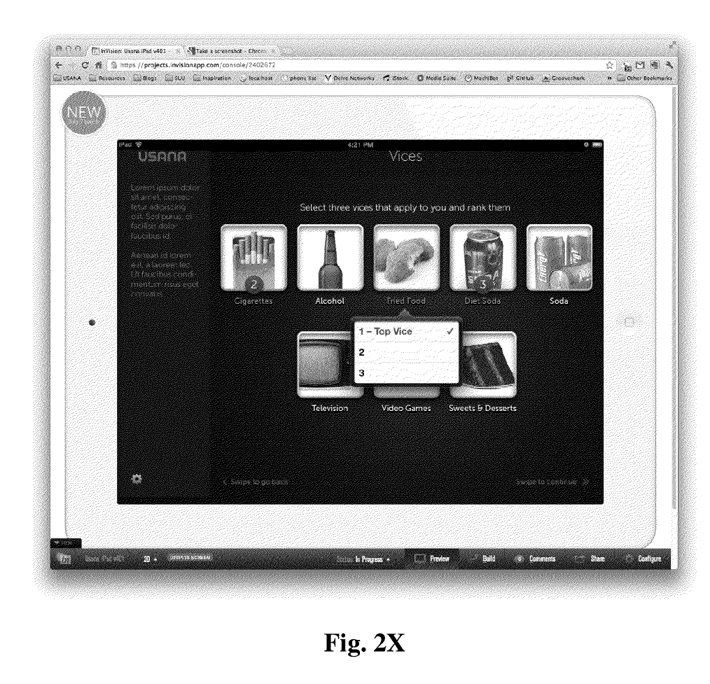

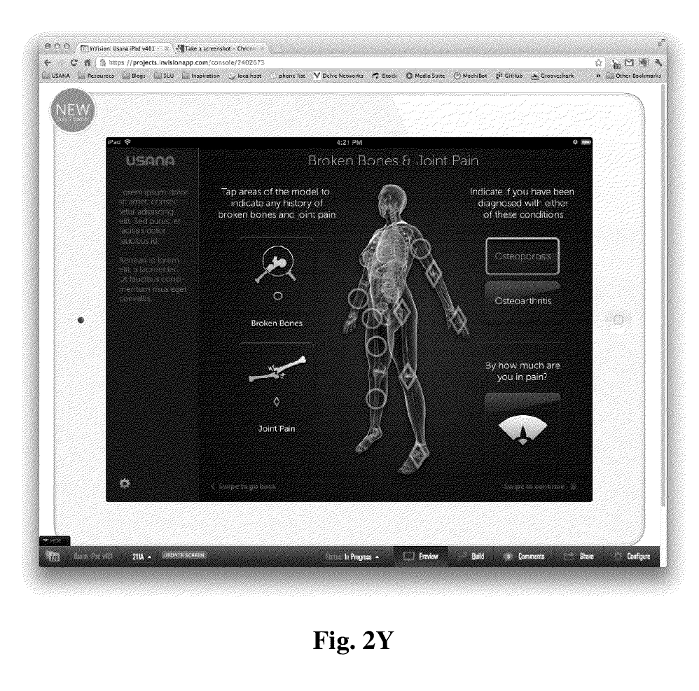

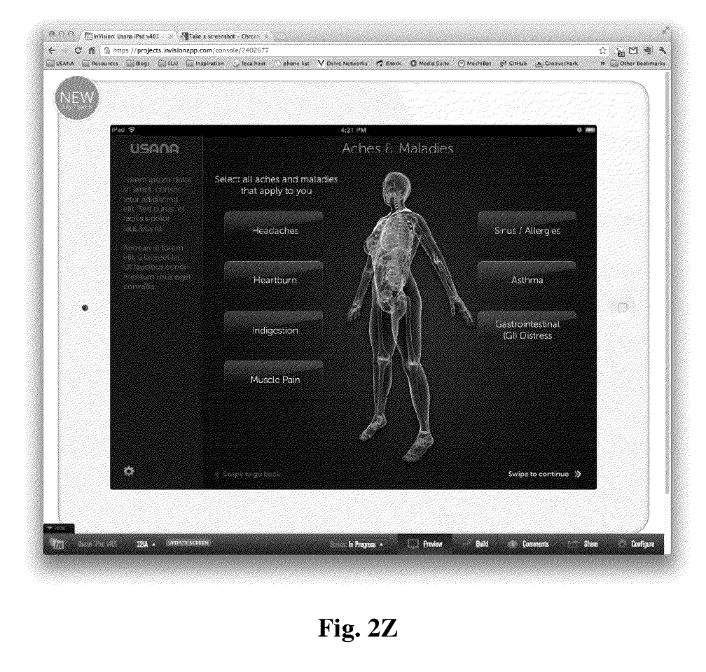

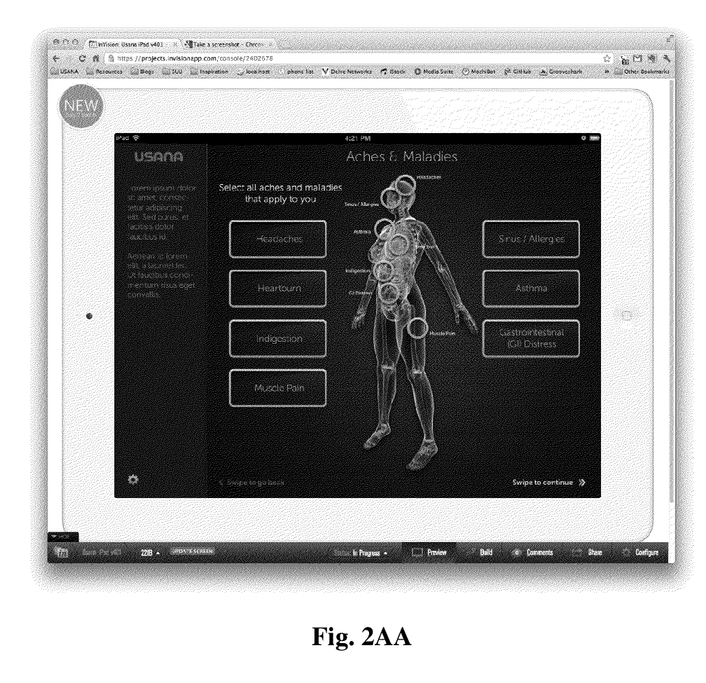

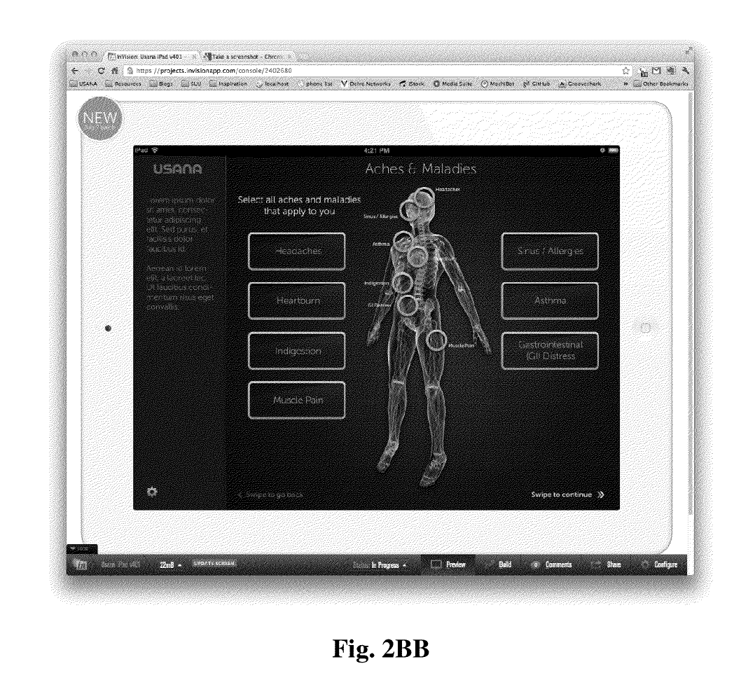

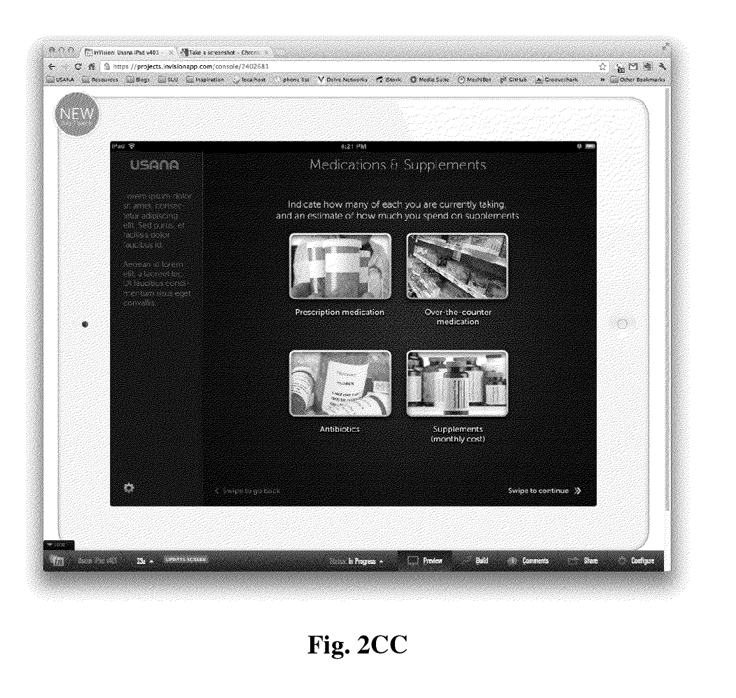

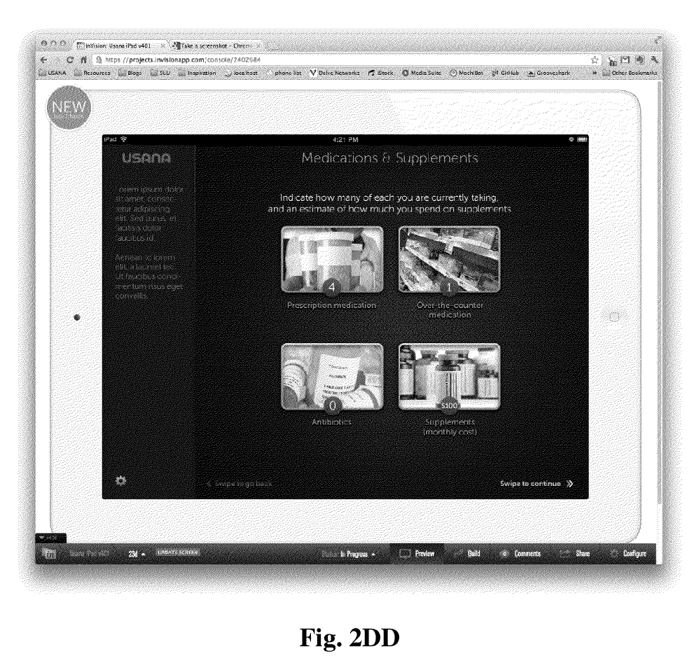

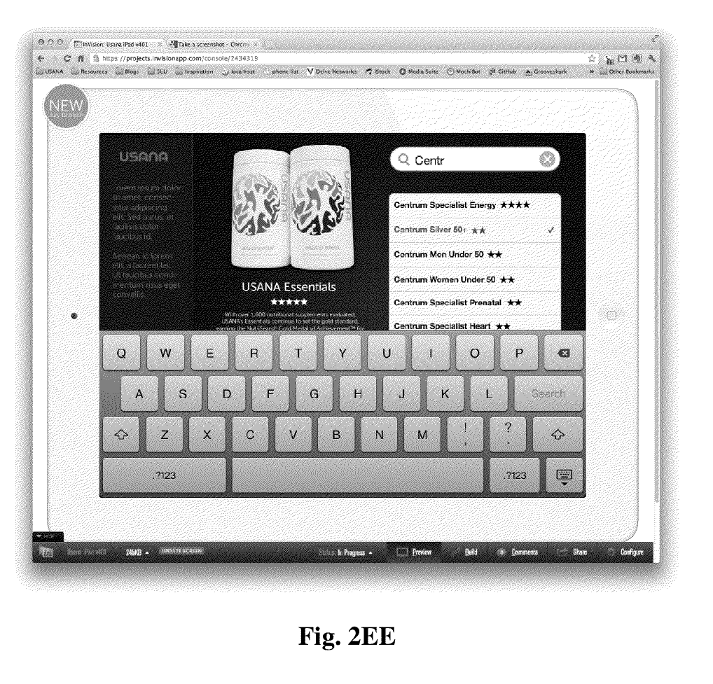

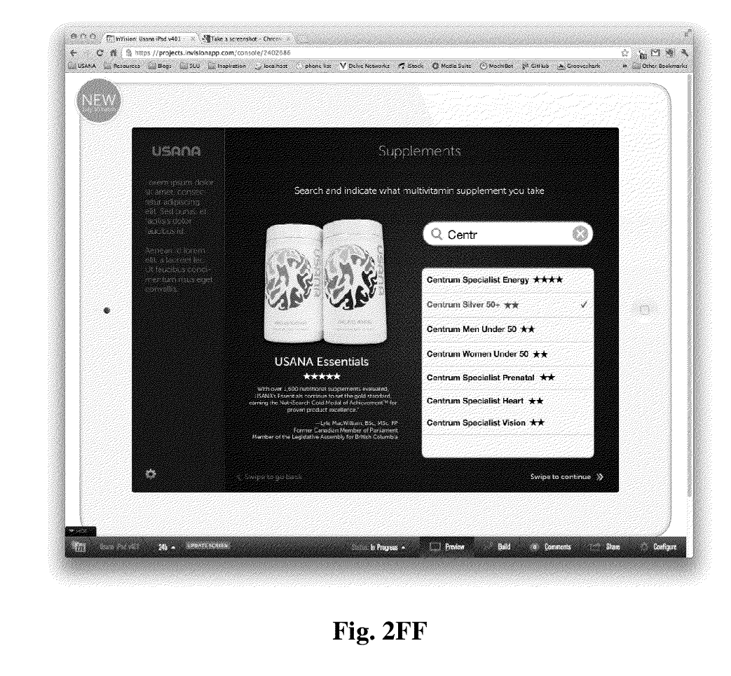

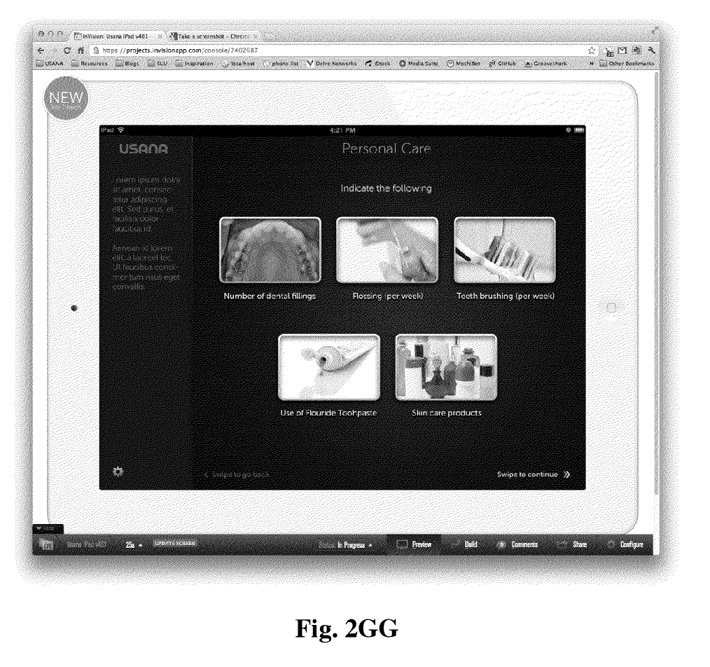

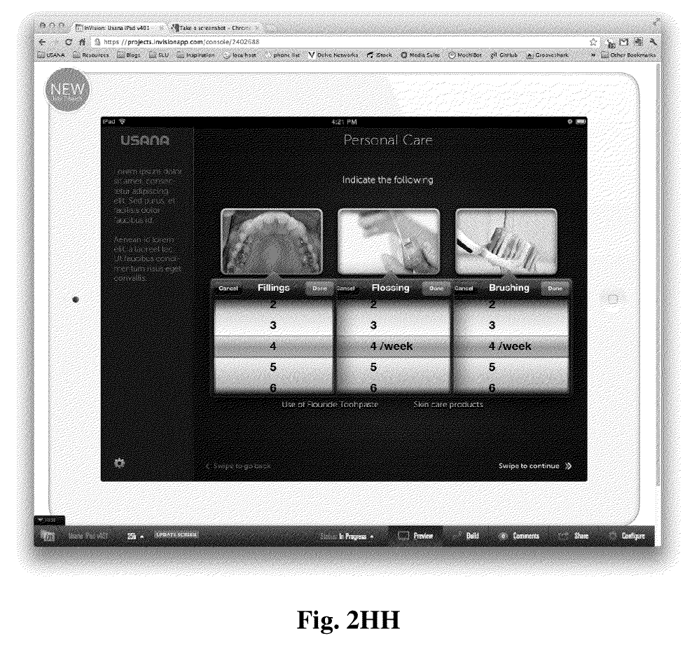

FIGS. 2A-2II illustrate various exemplary views of a user interface that could be displayed to the user during the online health assessment to obtain information from the user. The user provides input to the user interface to respond to various questions or requests.

For example, FIG. 2A provides representations of various health statuses ranging from Hospitalized to Athlete along with sliders to allow the user to specify a current health status and a desired health status by positioning the slider over the appropriate representation.

Additional information can also be obtained via the user interface provided by the online health assessment including demographic information (FIGS. 2B-2G), body measurements (FIGS. 2H-2O), the user's typical day (FIG. 2P), satisfaction and stress level from work (FIG. 2Q), home environment (FIG. 2R), current activity level (FIG. 2S), types of activities (FIG. 2T), food allergies and preferences (FIG. 2U), eating habits (FIG. 2V), health concerns (FIG. 2W), vices (FIG. 2X), injuries, pain, or other issues (FIGS. 2Y-2BB), medications and supplements (FIGS. 2CC-2FF), personal care (FIGS. 2GG-2HH), and exposure and water intake (FIG. 2II). The user interface could also prompt the user for additional information as desired.

The information obtained via the online health assessment can be used to identify lifestyle and/or nutrition/product changes that the user can make to potentially improve or maintain the user's health status. The identified changes can be presented to the user as lifestyle and/or nutrition/product recommendations.

In some embodiments, one or more lifestyle and/or nutrition/product recommendations are selected based on a comparison between the user's current health status and the user's desired health status. For example, if a user indicates that his current health is Average, but would like to have a future health status of Active (as shown in FIG. 2A), the selected recommendations can be different than if the user desires to have a future health status of Athlete.

The selection of lifestyle and/or nutrition/product recommendations can be based on any number and combination of the user's input data. For example, a hierarchical arrangement (such as a series of if conditions) may be used to drill down (or filter) to a particular recommendation based on the user's input corresponding to many different questions of the health assessment.

In a particular example, if the user indicates that he has a low activity level, an average current health, and a sedentary job, it can then be determined whether the user has a BMI and a belly circumference over a certain amount. If the user matches each of these criteria, a particular recommendation can be provided. In contrast, if the user matches only a subset of the criteria, other determinations can be made (e.g. a stress level in excess of some threshold) to identify a particular recommendation that best matches the user's status and goals.

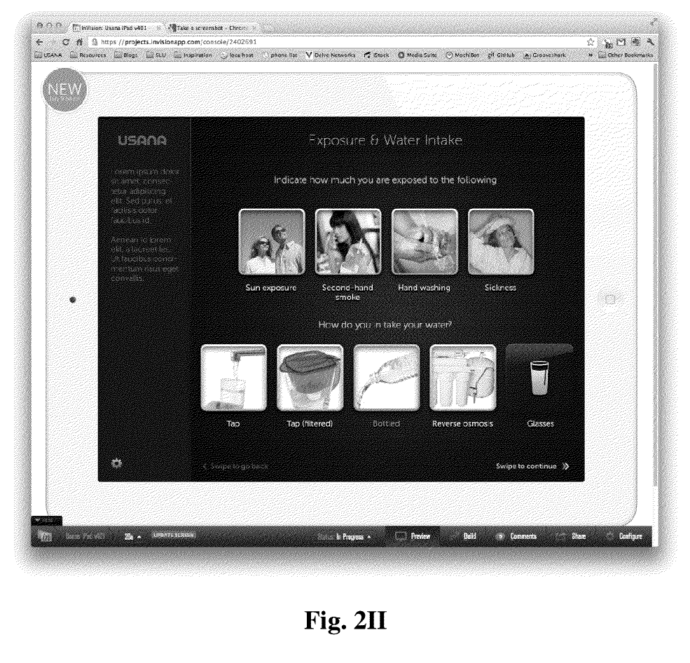

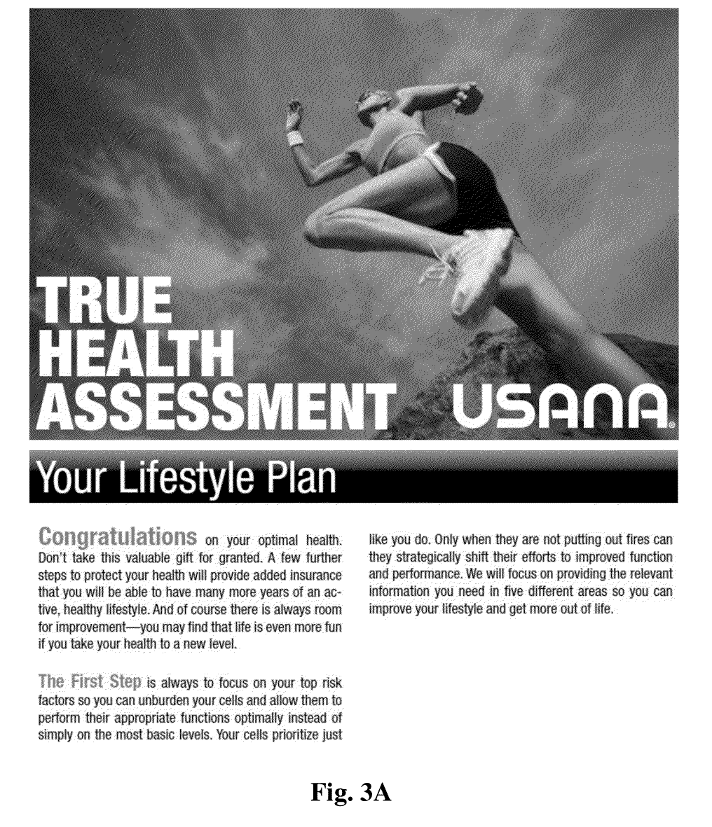

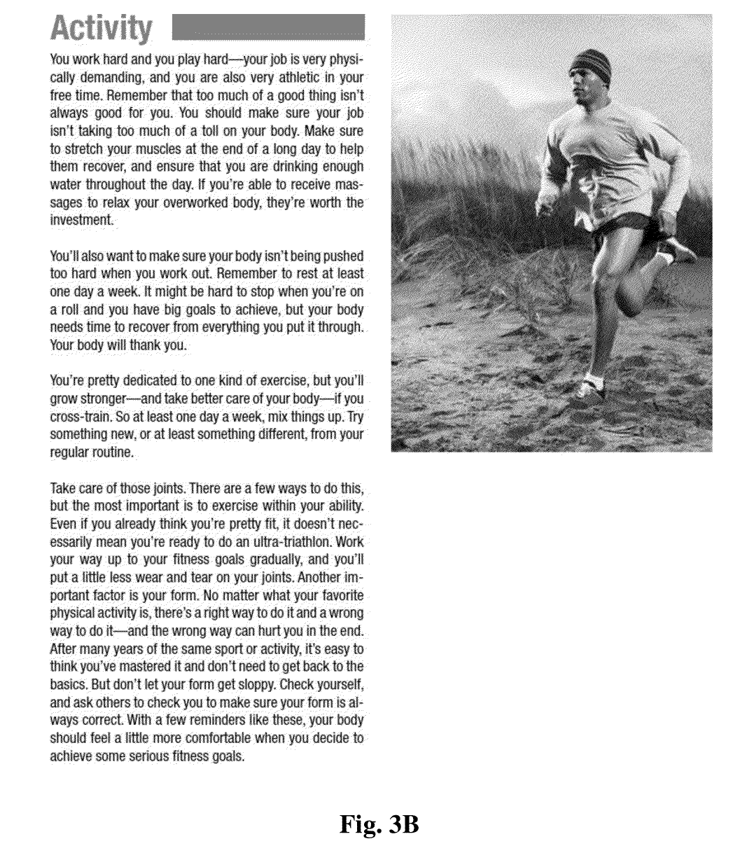

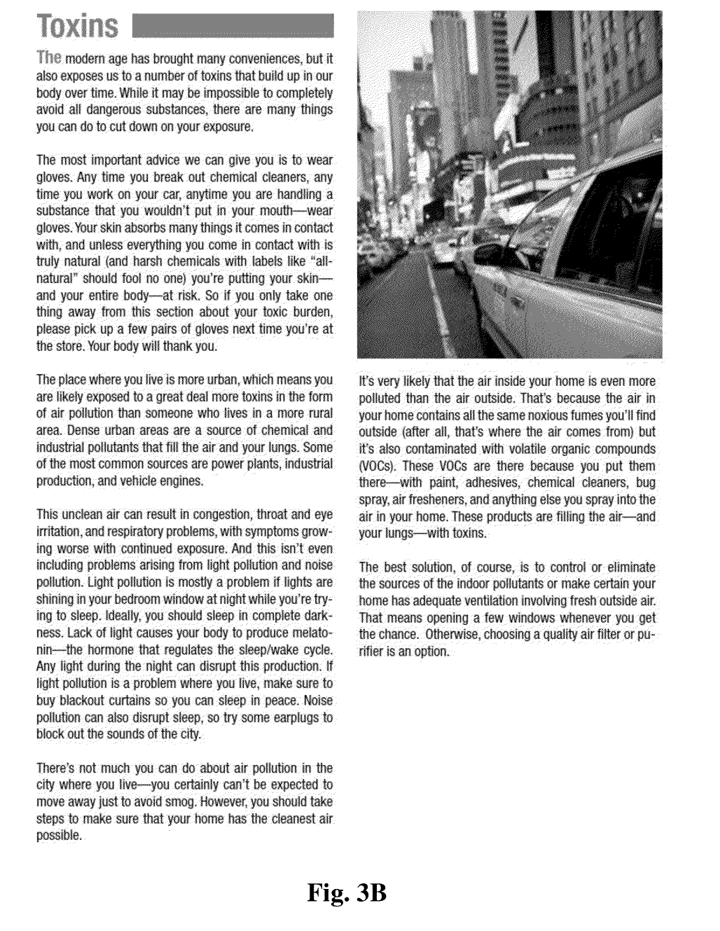

FIGS. 3A-3C illustrate a portion of an exemplary lifestyle plan that can be provided after a user has taken the online health assessment and one or more lifestyle recommendations have been selected to present to the user. The lifestyle plan can include any number of recommendations based on the user's input to the health assessment.

As shown in FIG. 3A, the user for whom the exemplary lifestyle plan was generated enjoys optimal health. This determination is based on the user's input during the health assessment. Even though it has been determined that the user has optimal health, various lifestyle and/or nutrition/product recommendations can still be provided to assist the user in balancing, maintaining, or improving some aspect of the user's lifestyle.

For example, as shown in FIG. 3B, various lifestyle recommendations are provided to assist the user to balance and optimize his current lifestyle. Similarly, FIG. 3B shows various lifestyle recommendations to assist the user in minimizing the effect of toxins in his life.

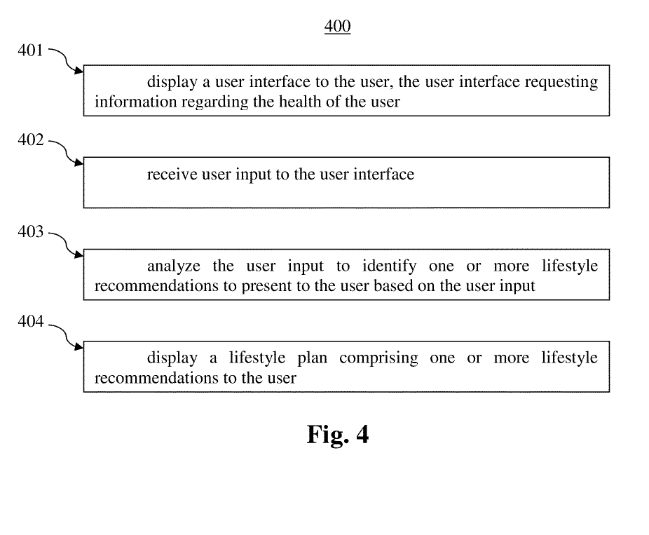

FIG. 4 illustrates a flowchart of an exemplary method 400 for selecting one or more lifestyle recommendations based on user input to an online health assessment. A similar method may be utilized to provide nutrition or other product recommendations and/or lifestyle and nutrition/product recommendations. Method 400 includes an act 401 of displaying a user interface to the user, the user interface requesting information regarding the health of the user. For example, the exemplary user interface shown in FIGS. 2A-2II, or a selected portion thereof, could be displayed to the user to receive user input.

Method 400 includes an act 402 of receiving user input to the user interface. For example, the user can interact with the user interface elements included in the user interface of FIGS. 2A-2II to provide input to the health assessment.

Method 400 includes an act 403 of analyzing the user input to identify one or more lifestyle recommendations to present to the user based on the user input. Finally, method 400 includes an act 404 of displaying a lifestyle plan comprising one or more lifestyle recommendations to the user. For example, the lifestyle plan shown in FIGS. 3A-3C can be displayed to the user to inform the user of changes the user can make to his lifestyle to balance, maintain, or otherwise improve his health.

In some embodiments, in addition to providing lifestyle recommendations, one or more products can also be recommended to assist the user in following a lifestyle recommendation. For example, if a user is provided a lifestyle recommendation to get more sleep, one or more sleep supplements can also be recommended to the user to assist the user to make this lifestyle change. In instances where a product is recommended to the user, the user may be provided with a mechanism to visit a seller of the product, such that the user may readily and quickly acquire the desired product. For example, the user may be provided with a direct link to a website selling the particular product recommended to the user. In some examples, a seller of products may be the provider of the health assessment, and recommendations provided by the health assessment may result in profits to the seller as users of the health assessment are recommended products sold by the seller.

The Appendix provides a listing of the logic that can be used to identify which lifestyle, nutrition, and/or product recommendations to present to a user. The logic comprises a series of if statements that form a hierarchical structure. Based on the user input, a particular path can be followed along the if statement hierarchical structure to identify a particular recommendation. For any particular user, multiple paths in the if statement hierarchical structure can followed to identify each recommendation to provide to the user.

When a particular user's input matches all conditions of an if statement, any recommendation associated with the if statement can be selected to be included in a lifestyle plan to be presented to the user. In this manner, the logic can be used to quickly identify a personalized lifestyle plan to present to the user when the user provides input (e.g. via the internet). In this sense, the if statements can function as filters for narrowing down the number of lifestyle recommendations that may apply to a user until a reasonable number of lifestyle recommendations have been identified as being applicable to the user.

The online health assessment can be provided in various forms including as a webpage accessible via a typical web browser or as a mobile application for a smart phone. In some embodiments, the format of the generated lifestyle plan can be determined based on the type of device the user is using to take the online health assessment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. In a computer system, a method for selecting one or more lifestyle recommendations based on user input to an online health assessment, the method comprising:
displaying a user interface to the user, the user interface requesting information regarding the health of the user;
receiving user input to the user interface;
analyzing the user input to identify one or more lifestyle recommendations to present to the user based on the user input; and
displaying a lifestyle plan comprising one or more lifestyle recommendations to the user.

2. The method of claim 1, wherein analyzing the user input to identify one or more lifestyle recommendations further comprises:
applying a series of hierarchical if statements to the user input to identify the one or more lifestyle recommendations.

3. The method of claim 1, further comprising:
identifying one or more products that can assist the user in following at least one of the one or more lifestyle recommendations; and
displaying the identified one or more products with the one or more lifestyle recommendations.

4. The method of claim 1, wherein analyzing the user input to identify one or more lifestyle recommendations to present to the user based on the user input comprises:
transmitting the user input via a network to one or more other computer systems; and
receiving the identified one or more lifestyle recommendations from the one or more other computer systems.

5. The method of claim 1, wherein the computer system is a portable electronic device.

6. The method of claim 1, wherein the user input identifies a current health status and a desired health status for the user.

7. The method of claim 6, wherein the health status is selected from a range of health statuses using a slider user interface element.

8. The method of claim 6, wherein the one or more lifestyle recommendations are identified based on a comparison between the user's current health status and desired health status.

9. The method of claim 8, wherein the comparison between the user's current health status and desired health status comprises a first filter for filtering out at least some of the possible lifestyle recommendations that can be provided to the user.

10. The method of claim 9, wherein the user input further identifies one or more additional categories of information consisting of one or more of the following:
demographic information, body measurements, the user's satisfaction level or stress level from work; a home environment, a current activity level, types of activities performed by the user, food allergies or preferences, eating habits, health concerns, vices, injuries or pain, medications or supplements, personal care, exposure, or water intake.

11. The method of claim 10, wherein the one or more additional categories of user input are used as one or more additional filters for filtering out an additional at least one or more possible lifestyle recommendations.

12. The method of claim 11, wherein the one or more additional categories are applied hierarchically.

13. One or more computer readable storage media storing computer executable instructions which when executed perform a method for selecting one or more lifestyle recommendations based on user input to an online health assessment, the method comprising:
displaying a user interface to the user, the user interface requesting information regarding the health of the user, the requested information including one or more of: body measurements, a work satisfaction level, a stress level, home information, activity level, or vices;
receiving user input to the user interface, the user input specifying at least some of the requested information;
analyzing the user input to identify one or more lifestyle recommendations to present to the user based on the user input; and
displaying a lifestyle plan comprising one or more lifestyle recommendations to the user.

14. The one or more computer readable storage media of claim 13, wherein analyzing the user input to identify one or more lifestyle recommendations further comprises:
applying a series of hierarchical if statements to the user input to identify the one or more lifestyle recommendations.

15. The one or more computer readable storage media of claim 13, further comprising:
identifying one or more products that can assist the user in following at least one of the one or more lifestyle recommendations; and
displaying the identified one or more products with the one or more lifestyle recommendations.

16. The one or more computer readable storage media of claim 15, further comprising providing an opportunity to purchase the one or more products.

17. The one or more computer readable storage media of claim 13, wherein the user input identifies a current health status and a desired health status for the user.

18. The one or more computer readable storage media of claim 17, wherein the health status is selected from a range of health statuses using a slider user interface element.

19. The one or more computer readable storage media of claim 18, wherein the one or more lifestyle recommendations are identified based on a comparison between the user's current health status and desired health status.

20. The one or more computer readable storage media of claim 19, wherein the comparison between the user's current health status and desired health status comprises a first filter for filtering out at least some of the possible lifestyle recommendations that can be provided to the user.
